(19) United States
(12) Patent Application Publication
(10) Pub. No.: US 2014/0279714 A1
(43) Pub. Date: Sep. 18, 2014

(54) ON-SITE FARM-TO-TABLE RESTAURANT WITH ON-DEMAND HARVESTING

(71) Applicant: Elie Gendloff, Oceanside, CA (US)

(72) Inventor: Elie Gendloff, Oceanside, CA (US)

(21) Appl. No.: 14/145,972

(22) Filed: Jan. 1, 2014

Related U.S. Application Data
(60) Provisional application No. 61/800,686, filed on Mar. 15, 2013.

(51) Int. Cl. G06Q 90/00

(52) U.S. Cl. CPC G06Q 90/00
USPC 705/500

(57) ABSTRACT

Provided is a restaurant comprising a garden, where a food ingredient of an item served in the restaurant is harvested from the garden after a customer orders the item. Also provided is a restaurant that serves an ingredient to a customer before the ingredient is harvested. Additionally provided is a restaurant that offers an item that has an ingredient that is harvested within six hours of the item being served to a customer.

### CROSS-REFERENCE TO RELATED APPLICATION

This application claims the benefit of U.S. Provisional Application No. 61/800,686, filed Mar. 15, 2013, and incorporated by reference herein in its entirety.

### BACKGROUND OF THE INVENTION

(1) Field of the Invention

The present invention generally relates to restaurants. More specifically, the invention is directed to a restaurant that serves food items having the freshest possible ingredients, where the items are served within six hours of harvesting an ingredient in the item, and/or where the ingredient is harvested after a customer of the restaurant orders an item having the ingredient.

(2) Description of the Related Art

When a plant food ingredient such as a fruit or vegetable is harvested, the harvested ingredient responds to the harvesting injury within minutes (Reilly et al., 2003, Plant Mol. Biol. 53:669-685), leading to significant changes to the composition of that ingredient within hours of harvest (King, G. A. and S. C. Morris, 1994, J. Amer. Soc. Hort Sci. 119: 270-275; Afoakwa et al., 2001, Food chemistry 75:85-91; Ryoichi Masuda, pp. 92-102 in Vegetable Soybean: Research Needs for Production and Quality Improvement, S. Shanumgasandaram, Ed. 1991, ISBN: 92-9058-047-X; Degl'Innocenti et al., 2005, J. Agric. Food Chem. 53:9980-9984). For example, differences in broccoli toughness (“breaking force”) can occur within six hours of harvest (Baclayon et al., 2007, J. Biol. Sci. 7:614-619). Additionally, activity of the enzyme phenylalanine ammonia lyase (PAL) can change significantly within twelve hours of harvest (Bhowmik and Matsu, 2005, Z. Naturfursch. 60c:128-132). This change in PAL activity can exacerbate toughness, since PAL catalyzes the committed step in phenylpropanoid metabolism, which leads to lignin biosynthesis. Lignin is an important structural component in plant cell walls. Many flavor components of fruits and vegetables are also made through the phenylpropanoid pathway, indicating that changes in PAL likely lead to changes in flavor. Indeed, measurable changes in sensory panel scores have been demonstrated in soybeans within 10 hours of harvest (Masuda, 1991).

The early compositional changes in harvested ingredients increase over time, in an irreversible process termed “senescence,” which eventually leads to cellular breakdown and death of the ingredient. For this reason, fresh ingredients are an essential component of nutritious, high quality food.

Even though food ingredients begin to deteriorate within hours of harvest, restaurants do not generally use food ingredients that have been harvested less than a day before utilization due to the logistical difficulty in obtaining fresher ingredients, and because the rapidity of the changes in food after harvest has not been generally appreciated. Even restaurants that have gardens on site generally harvest the ingredients at least several hours before the food is prepared. An exception is the Trellis Restaurant in Kirkland Wash., which seasonally offers a “Two-Hour Salad” with ingredients harvested within two hours of being served (heathmankirkland[dot]com/trellis/kirkland-washington-restaurants[dot]aspx). Thus, most restaurant customers are unable to obtain a meal that uses food ingredients that are not altered somewhat from harvest.

There is therefore a need for a restaurant that utilizes food ingredients that are unchanged from harvest. The present invention addresses that need.

### BRIEF SUMMARY OF THE INVENTION

The present invention provides a restaurant and garden where the restaurant utilizes the freshest food ingredients possible. That is accomplished by harvesting a food ingredient within six hours of serving an item containing that ingredient, or harvesting a food ingredient after an item having the food ingredient is ordered by a restaurant customer.

Thus, in some embodiments, a restaurant comprising a garden is provided. In these embodiments, at least one food ingredient of an item served in the restaurant is harvested from the garden after a diner orders the item.

In other embodiments, a restaurant is provided. The restaurant comprises (a) a garden, and (b) a menu listing at least one item that has an ingredient that is in the garden and stating that the ingredient will be harvested from the garden after the item is ordered.

In additional embodiments, a restaurant is provided that, at least three days per week, offers an item that has an ingredient that is harvested within six hours of the item being served to a customer.

### DETAILED DESCRIPTION OF THE INVENTION

As used herein, the singular forms “a”, “an” and “the” are intended to include the plural forms as well, unless the context clearly indicates otherwise. Additionally, the use of “or” is intended to include “and/or”, unless the context clearly indicates otherwise.

Provided herewith is a restaurant associated with a garden that provides the freshest ingredients possible, by harvesting ingredients for the restaurant from the garden after a customer of the restaurant orders an item having the ingredient.

Thus, in some embodiments, a restaurant comprising a garden is provided. In these embodiments, at least one food ingredient of an item served in the restaurant is harvested from the garden after a customer of the restaurant orders the item.

As used herein, a “restaurant” is an establishment where food and/or beverages are served to paying customers. The restaurant can be any size or design and can comprise a portable food cart, a farm stand, or a permanent structure. It can also be an independent business or associated with another business, e.g., a hotel or office building.

As used herein, a “customer” is a person that buys an item (food or drink) from the restaurant by ordering the item, then receiving the item from the restaurant after the item is prepared. The item can be ordered at the restaurant or remotely, e.g., by telephone, facsimile or via the internet. The item can be taken out of the restaurant by the customer, delivered to the customer at an address away from the restaurant, or consumed in the restaurant. The item can have multiple ingredients, at least one of which is harvested from the garden after a customer of the restaurant orders the item.

As used herein, a “garden” is an area having an ingredient that is purposefully cultivated to be used for food. Thus, ingredients that are foraged from uncultivated land are not considered herein to be cultivated in a garden.

As used herein, the garden associated with the restaurant can grow ingredients of any type, including but not limited to a vegetable (e.g., a green vegetable), an herb, a mushroom, a spice, a fruit of a tree, bush or perennial shrub, an animal product (e.g., milk or eggs), or an animal (e.g., a fish, a poultry animal, or a mammal). An animal grown within the restaurant, e.g., a lobster growing in a tank in the restaurant, is not considered herein to be an ingredient in the garden. However, in some embodiments, customers of the restaurant can dine in the garden. In various embodiments, the ingredient is not the meat of a mammal or poultry.

It is understood that, for various food items, only a portion of the ingredient that is harvested from the garden will be used in the item. For example, the core of an apple harvested from the garden might not be used in the food item having that ingredient.

The garden may be adjacent to the restaurant or a distance (e.g., 100 feet, 500 feet, 1000 feet, 2000 feet, one mile or more, or any distance in between) from the restaurant. The garden and restaurant need not be owned or controlled by the same entity. Having the garden adjacent to the restaurant is most convenient. As used herein, an ingredient is harvested from the garden when the ingredient is cut or removed from the garden such that it ceases to be a part of the garden. A fruit or vegetable that has fallen from a plant is considered harvested when the fruit or vegetable falls from the plant.

It is contemplated that the ingredient is usually harvested by an employee of the restaurant and/or the garden. However, in some embodiments, the customer goes into the garden and harvests the ingredient, either alone or accompanied by a restaurant/garden employee.

If the customer is in the restaurant and prepared to dine when ordering an item having an ingredient that is harvested after ordering, the item would normally be served within an hour of the harvest of the ingredient. However, if the customer orders the item remotely, e.g., via telephone or internet, it is possible that the ingredient could be harvested many hours before the item is served. In order to assure freshness, it is preferred that the food ingredient is harvested within six hours of when the item is served to the customer.

In some of these embodiments, the food ingredient is harvested within three hours of when the item is served to the customer. This assures that the food ingredient is very fresh at serving, with minimal or no changes (other than those caused in preparation, e.g., by cooking) from when it was harvested.

In additional embodiments, the food ingredient is harvested within one hour of when the item is served to the customer. This assures that the food ingredient is virtually unchanged at serving (other than by preparation) from when it was harvested.

In some embodiments, the restaurant further comprises a menu having at least one, two, three, four or five items listed therein that comprise an ingredient that is harvested from the garden after the customer orders the item. As used herein, a “menu” is a list of the items available for ordering in the restaurant. The menu can be presented in any manner, including but not limited to (a) being placed on a wall of a restaurant, (b) a hand-held paper or folio that can be separately given to each customer or left at a location away from the restaurant, (c) on the restaurant's web page on the internet, or (d) a listing verbally provided by an employee of the restaurant or by a recording, e.g., by telephone or on the internet.

In some embodiments, the menu lists, at least once a month over any two month, three month, four month, five month or six month period, at least two, three, four or five items that comprise an ingredient that is harvested from the garden after the customer orders the item. In other embodiments, at least 5%, 10%, 20%, 30%, 40%, 50%, 60%, 70%, 80%, 85%, 90%, 95%, or 100% of the time over any one, two, three, four, five or six calendar months, the menu lists at least one, two, three, four or five items that comprise an ingredient that is harvested from the garden after the customer orders the item.

In various embodiments, the menu indicates that the ingredient will be harvested from the garden after the item is ordered. In some of these embodiments, the menu further indicates that the item will be served within six hours, five hours, four hours, three hours, two hours, one hour, thirty minutes, fifteen minutes, or any time in between, of the harvesting of the ingredient.

In various embodiments, the restaurant further provides a way for the customer to observe an employee of the restaurant harvest an ingredient (e.g., an ingredient used in an item ordered by the customer) from the garden. Nonlimiting examples include (a) at least one closed circuit camera directed toward the garden and a monitor or other closed circuit feed (e.g., transmitted through a wireless transmitter to allow the customer to observe the harvest on a computer or smart phone) allowing the customer to observe the camera feed, or (b) a window in the restaurant overlooking the garden.

In additional embodiments, an employee of the restaurant brings the harvested ingredients to the customer before the food item having that ingredient is prepared. In some of these embodiments, the harvested ingredients are subject to customer approval after inspection.

Also provided herewith is a restaurant comprising (a) a garden, and (b) a menu listing at least one, two, three, four or five items that have at least one ingredient that is in the garden and stating that the ingredient will be harvested from the garden after the item is ordered. In these embodiments, the restaurant, garden, menu, ingredient, harvesting procedure, and item is as described and/or defined above.

In additional embodiments, a menu for any of the above-described restaurants is provided. In these embodiments, the menu lists at least one item that has any of the above-described ingredients, wherein the menu further states that the ingredient will be harvested from the garden after the item is ordered. All aspects of these embodiments are as described above.

Also provided herewith is a method of serving a customer of any of the above-described restaurants. The method comprises harvesting an ingredient of an item ordered by a restaurant customer from a garden after the customer orders the item.

In some embodiments, the food ingredient is harvested within three hours of when the item is served to the customer. In other embodiments, the food ingredient is harvested within one hour of when the item is served to the customer.

Also provided is a restaurant that serves an ingredient to a customer before the ingredient is harvested, e.g., where the ingredient is part of a plant growing in a container. For example, the restaurant may offer crackers with mozzarella cheese and basil, where the basil is served growing in a container such that the customer can pick off leaves of the basil plant tableside to combine with the mozzarella cheese and crackers. Examples of ingredients that may be served to a customer before harvest are a green vegetable, an herb, a spice, a vegetable, a mushroom, and a fruit of a tree, bush or perennial herb.

Also provided is a restaurant that, at least three days per week for at least three consecutive months, offers an item that has an ingredient that is harvested within six hours of the item being served to a customer (“six-hour harvested ingredient”). In some embodiments, the item is served to the customer within three hours of harvest of the ingredient. In other embodiments the item is served to the customer within one hour of harvest of the ingredient. In additional embodiments, the item is offered for at least four, five, six, seven, eight, nine, ten, eleven, or twelve consecutive months.

While the Trellis Restaurant in Kirkland Wash., has seasonally offered a “Two-Hour Salad” with ingredients harvested within two hours of being served, the restaurant described herein is distinguished by offering items having a six-hour harvested ingredient over an extended period, not just at certain times of the year. The invention restaurant thus provides a constant, not just seasonal, offering of items having a six-hour harvested ingredient.

In some of these embodiments, the ingredient is harvested before the customer orders the item. In other embodiments, the ingredient is harvested after the customer orders the item.

The practice of serving an item having an ingredient that is harvested within six hours or less of the item being served to a customer can be part time or full time at the restaurant. In some embodiments, the practice is at least five days a week. In other embodiments, the practice is less than five days a week. In additional embodiments, at least one item having an ingredient that is harvested within six hours of the item being served is offered substantially each day the restaurant is opened.

It is contemplated that the ingredient is usually harvested by an employee of the restaurant and/or the garden. However, in some embodiments, the customer goes into the garden and harvests the ingredient, either alone or accompanied by a restaurant/garden employee.

In some embodiments, the restaurant further comprises a menu having at least one item listed therein having an ingredient that is harvested within six hours of the item being served. The menu is as described previously. The menu can be present at the restaurant and/or accessible remotely (e.g., on the internet or by paper flyers) from the restaurant.

The menu can, some of the time or all of the time, have any number of items listed therein having an ingredient that is harvested within six hours of the item being served. For example, the menu can, at least once a month, have at least three items on the menu that comprise an ingredient that is harvested from the garden within six hours of the item being served. As other examples, the menu can, at least 30% of the time, 50% of the time, or 80% of the time, over one, two, three, four, five, six or more calendar months, have at least one item on the menu that comprises an ingredient that is harvested from the garden within six hours of the item being served.

In view of the above, it will be seen that several objectives of the invention are achieved and other advantages attained.

As various changes could be made in the above methods and compositions without departing from the scope of the invention, it is intended that all matter contained in the above description and shown in the accompanying drawings shall be interpreted as illustrative and not in a limiting sense.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

1. A restaurant comprising a garden, wherein at least one food ingredient of an item served in the restaurant is harvested from the garden after a customer of the restaurant orders the item, wherein the ingredient is a green vegetable, an herb, a spice, a vegetable, a mushroom, a fruit of a tree, bush or perennial herb, an egg or milk.

2. (canceled)

3. The restaurant of claim 1, wherein the food ingredient is harvested within three hours of when the item is served to the customer.

4. The restaurant of claim 1, wherein the food ingredient is harvested within one hour of when the item is served to the customer.

5. The restaurant of claim 1, wherein the garden is adjacent to the restaurant.

6. The restaurant of claim 1, further comprising a menu having at least one item listed therein that comprises an ingredient that is harvested from the garden after the customer orders the item.

7. The restaurant of claim 1, further comprising a menu that lists, at least once a month, at least three items that comprise an ingredient that is harvested from the garden after the customer orders the item.

8-10. (canceled)

11. The restaurant of claim 1, further comprising at least one closed circuit camera and monitor allowing the customer to observe an employee of the restaurant harvest the ingredient from the garden.

12. The restaurant of claim 1, having a window overlooking the garden such that a customer in the restaurant can observe an employee of the restaurant harvest the ingredient from the garden.

13. The restaurant of claim 1, wherein the ingredient is a green vegetable or an herb.

14. The restaurant of claim 1, wherein the ingredient is a vegetable or a mushroom.

15. The restaurant of claim 1, wherein the ingredient is a fruit of a tree, bush or perennial herb.

16. The restaurant of claim 1, wherein the ingredient is an egg or milk.

17. A menu for the restaurant of claim 1, where the menu lists at least one item that has the ingredient.

18. The menu of claim 17, wherein the menu further indicates that the ingredient will be harvested from the garden after the item is ordered.

19-20. (canceled)

21. The menu of claim 17, wherein the menu further indicates that the item will be served within one hour of the harvesting of the ingredient.

22. A method of serving a customer of the restaurant of claim 1, the method comprising harvesting an ingredient of an item ordered by the customer from a garden after the customer orders the item.

23. (canceled)

24. The method of claim 22, wherein the ingredient is harvested from the garden within three hours of the customer ordering the item.

25. The method of claim 22, wherein the ingredient is harvested from the garden within one hour of the customer ordering the item.

26. A restaurant that serves an ingredient to a customer before the ingredient is harvested, wherein the ingredient is a green vegetable, an herb, a spice, a vegetable, a mushroom, or a fruit of a tree, bush or perennial herb.

27. A restaurant that, at least three days per week for at least three consecutive months, offers an item that has an ingredient that is harvested within six hours of the item being served to a customer.

28-39. (canceled)
